(19) United States
(12) Patent Application Publication
(10) Pub. No.: US 2016/0191576 A1
(43) Pub. Date: Jun. 30, 2016

(54) METHOD FOR CONDUCTING A COLLABORATIVE EVENT AND SYSTEM EMPLOYING SAME

(71) Applicant: SMART Technologies ULC, Calgary (CA)

(72) Inventors: Sean Thompson, Calgary (CA); Michael Rounding, Calgary (CA)

(21) Appl. No.: 14/587,579

(22) Filed: Dec. 31, 2014

(51) Int. Cl. H04L 29/06; G06F 3/0488; G06F 3/0484; H04L 29/08

(52) U.S. Cl. CPC H04L 65/403; H04L 67/06; H04L 67/10; G06F 3/04886; G06F 3/04847

(57) ABSTRACT

A method of conducting a collaborative event comprises receiving, by at least one computing device, a shared file from a participant computing device joined to the collaborative event; displaying the shared file on at least one interactive board in communication with the at least one computing device during the collaborative event; and sending an updated shared file from the at least one computing device to the participant computing device, the updated shared file comprising at least user input injected into the received shared file using the at least one interactive board.

### FIELD

The subject application relates generally to collaboration systems and in particular, to a method for conducting a collaborative event and to a collaboration system employing the same.

### BACKGROUND

Interactive input systems that allow users to inject input such as for example digital ink, mouse events etc. into an application program using an active pointer (e.g. a pointer that emits light, sound or other signal), a passive pointer (e.g., a finger, cylinder or other object) or other suitable input device such as for example, a mouse or trackball, are well known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 and in U.S. Patent Application Publication No. 2004/0179001, all assigned to SMART Technologies ULC of Calgary, Alberta, Canada, assignee of the subject application, the entire disclosures of which are incorporated herein by reference; touch systems comprising touch panels employing electromagnetic, capacitive, acoustic or other technologies to register pointer input; tablet and laptop personal computers (PCs); smartphones, personal digital assistants (PDAs) and other handheld devices; and other similar devices.

Conferencing and other event management systems, such as Microsoft® Live Meeting, Citrix® GoToMeeting®, SMART Bridgit™, and the like are also well known. These systems allow participants at different geographical locations to participate in a collaborative session using computing devices, by sharing content, such as, screen images and files, or a common page on a touch panel, an interactive board or whiteboard (IWB). For example, the SMART Bridgit™ version 4.2 conferencing system offered by SMART Technologies ULC, comprises one or more servers and clients, and provides plug-ins for event scheduling programs, such as, Microsoft Exchange® or Microsoft Outlook®. An event may be scheduled in Microsoft Outlook® via a SMART Bridgit™ plug-in on a participant's computing device, by assigning a name, a start time and an end time to the event. Using a SMART Bridgit™ client program, a user may create an event session on the SMART Bridgit™ server to start an ad-hoc event. Other participants may join the event session using the SMART Bridgit™ client program running on their computing devices by entering the event name and any required password. In addition to sharing content, participants can annotate shared screen images by injecting digital ink thereon using for example a computer mouse, a touch screen, or an interactive whiteboard.

As will be appreciated, data shared during a collaborative event may be proprietary or confidential, and in some cases it may be desirable to limit distribution and storage of the data. It is therefore an object to provide a novel method for conducting a collaborative event and a novel collaboration system employing the same.

### SUMMARY

Accordingly, in one aspect there is provided a method of conducting a collaborative event, comprising: receiving, by at least one computing device, a shared file from a participant computing device joined to the collaborative event; displaying the shared file on at least one interactive board in communication with the at least one computing device during the collaborative event; and sending an updated shared file from the at least one computing device to the participant computing device, the updated shared file comprising at least user input injected into the received shared file using the at least one interactive board.

One or more additional participant computing devices may be joined to the collaborative event, and wherein the sending comprises sending the updated shared file from the at least one computing device to only the participant computing device from which the shared file was received.

The method may further comprise displaying an image of both the shared file and the user input on each participant computing device during the collaborative event.

The method may further comprise displaying a virtual button on each interactive board during the collaborative event, wherein selection of the virtual button initiates the sending. Selection of the virtual button may cause the collaborative event to end. The method may further comprise, after the sending, deleting from the at least one computing device one or both of the received shared file and the updated shared file. The updated shared file and the received shared file may have the same file format.

In another aspect, there is provided a non-transitory computer-readable medium having embodied thereon a computer program for conducting a collaborative event, the program comprising instructions which, when executed by processing structure of at least one computing device, carry out: receiving, by the at least one computing device, a shared file from a participant computing device joined to the collaborative event; displaying the shared file on at least one interactive board in communication with the at least one computing device during the collaborative event; and sending an updated shared file from the at least computing device to the participant computing device, the updated shared file comprising at least user input injected into the received shared file using the at least one interactive board.

In another aspect, there is provided a collaboration system comprising: at least one computing device in communication with a collaboration server computing device running a collaboration management application for hosting a collaborative event; a participant computing device in communication with the at least one computing device, the at least one computing device being configured to receive a shared file from the participant computing device during the collaborative event; and at least one interactive board in communication with the at least one computing device, each interactive board being configured, during the collaborative event, to display the shared file, wherein the at least one computing device is further configured to send an updated shared file to the participant computing device, the updated shared file comprising at least user input injected into the received shared file using the at least one interactive board.

In another aspect, there is provided an interactive board configured to: during a collaborative event, display content of a shared file received from a participant computing device in communication therewith and joined to the collaborative event; receive user input injected during the collaborative event; and communicate the user input to a computing device in communication with the interactive board, the computing device being configured to send an updated shared file to the participant computing device, the updated shared file comprising at least the injected user input.

In another aspect, there is provided a participant computing device configured to: during a collaborative event, send a shared file to at least one computing device for display on at least one interactive board; and receive an updated shared file from the at least one computing device, the updated shared file comprising at least user input injected into the received shared file using the at least one interactive board.

### BRIEF DESCRIPTION OF THE DRAWINGS

Embodiments will now be described more fully with reference to the accompanying drawings in which:

FIG. 1 is a schematic perspective view of a collaboration system;

FIG. 2 is a schematic view of an interactive board and a participant computing device forming part of the collaboration system of FIG. 1, the participant computing device presenting a file share screen;

FIG. 3 is a schematic view of the interactive board and the participant computing device of FIG. 2, the participant computing device presenting a share destination screen;

FIG. 4 is a schematic view of the interactive board and the participant computing device of FIG. 2, the interactive board displaying content of a shared file and the participant computing device presenting an updated file share screen;

FIG. 5 is a schematic view of the interactive board of FIG. 4, updated to include user input in the form of digital ink;

FIG. 6 is a schematic view of the interactive board of FIG. 5, showing selection of a “return to sender” virtual button by a user; and

FIG. 7 is a schematic view of the interactive board of FIG. 5 and the participant computing device of FIG. 2, the participant computing device presenting the file share screen showing a virtual button corresponding to an updated shared file.

### DETAILED DESCRIPTION OF EMBODIMENTS

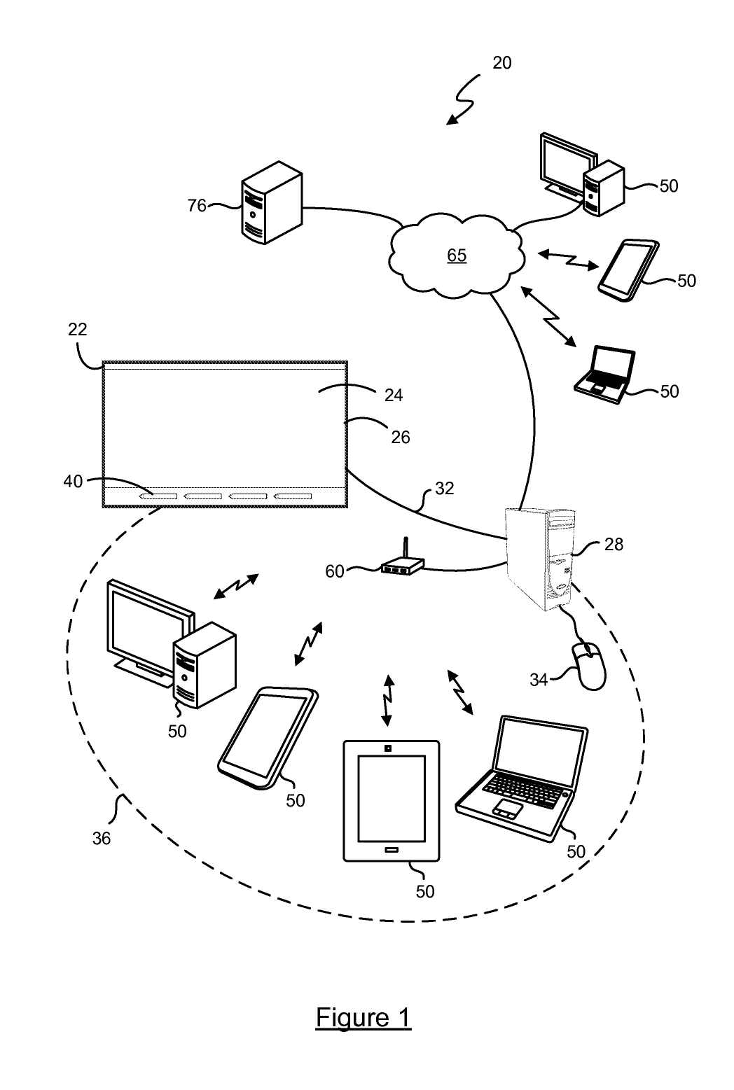

Turning now to FIG. 1, a collaboration system 20 is shown. In this embodiment, the collaboration system 20 comprises at least one general purpose computing device 28 installed in a collaboration site, such as for example, a meeting room, a classroom, a lecture theater, etc. An interactive board 22 is mounted on a generally vertical support surface such as for example, a wall surface or the like or is otherwise supported or suspended in an upright orientation and is connected to the general purpose computing device 28 via a universal serial bus (USB) cable 32 or other suitable wired or wireless communication link. Interactive board 22 comprises a generally planar, rectangular interactive surface 24 that is surrounded about its periphery by a bezel 26. An image, such as for example a computer desktop is displayed on the interactive surface 24. In this embodiment, the interactive board 22 uses a liquid crystal display (LCD) panel having a display surface defining the interactive surface 24 to display the images. The interactive board 22 allows a user to inject input such as digital ink, mouse events etc. into an application program executed by the general purpose computing device 28.

The interactive board 22 employs machine vision to detect one or more pointers brought into a region of interest in proximity with the interactive surface 24, and transmits pointer data to the general purpose computing device 28 via the USB cable 32. The general purpose computing device 28 processes the output of the interactive board 22 and adjusts image data that is output to the interactive board 22, if required, so that the image presented on the interactive surface 24 reflects pointer activity. In this manner, the interactive board 22 and the general purpose computing device 28 allow pointer activity proximate to the interactive surface 24 to be recorded as writing or drawing or used to control execution of one or more application programs executed by the general purpose computing device 28.

Imaging assemblies (not shown) are accommodated by the bezel 26, with each imaging assembly being positioned adjacent a different corner of the bezel. Each of the imaging assemblies comprises an image sensor and associated lens assembly that provides the image sensor with a field of view sufficiently large as to encompass the entire interactive surface 24. A digital signal processor (DSP) or other suitable processing device associated with each image sensor sends clock signals to the image sensor causing the image sensor to capture image frames at the desired frame rate.

The imaging assemblies are oriented so that their fields of view overlap and look generally across the entire interactive surface 24. In this manner, any pointer 40 such as for example a user's finger, a cylinder or other suitable object, or a passive or active pen tool or eraser tool that is brought into proximity of the interactive surface 24 appears in the fields of view of the imaging assemblies and thus, is captured in image frames acquired by multiple imaging assemblies. When the imaging assemblies acquire image frames in which a pointer exists, the imaging assemblies convey the image frames to a master controller. The master controller in turn processes the image frames to determine the position of the pointer in (x,y) coordinates relative to the interactive surface 24 using triangulation. The pointer coordinates are then conveyed to the general purpose computing device 28 which uses the pointer coordinates to update the image displayed on the interactive surface 24 if appropriate. Pointer contacts on the interactive surface 24 can therefore be recorded as writing or drawing or used to control execution of application programs running on the general purpose computing device 28.

The general purpose computing device 28 in this embodiment is a general purpose computer or other suitable processing device comprising, for example, a processing unit comprising one or more processors, system memory (volatile and/or non-volatile memory), other non-removable or removable memory (e.g., a hard disk drive, RAM, ROM, EEPROM, CD-ROM, DVD, flash memory, etc.) and a system bus coupling the various computer components to the processing unit. User input or commands may also be provided to the general purpose computing device 28 through a mouse 34, a keyboard (not shown) or other suitable input device. Other input techniques such as voice or gesture-based commands may also be used to enable user interaction with the collaboration system 20.

The general purpose computing device 28 is communicatively coupled to a wireless network device 60 and is configured to control the wireless network device 60 to provide a wireless network 36 over which participant computing devices 50 communicate. The participant computing devices 50 may be for example, desktop computers, tablet computers, laptop computers, smartphones, personal digital assistants, etc. In this embodiment, the wireless network 36 is assigned a wireless network service set identifier (SSID) and communications via the wireless network device 60 are encrypted using a security protocol, such as Wi-Fi Protected Access II (WPA2) protocol with a customizable network key. Methods for conducting a collaborative event utilizing an SSID are described in U.S. Patent Application Publication No. 2013/0262686 assigned to SMART Technologies ULC, the relevant portions of the disclosure of which are incorporated herein by reference.

The general purpose computing device 28 is also communicatively coupled to a network 65 over either a wired connection, such as an Ethernet, or a wireless connection, such as Wi-Fi, Bluetooth, etc. The network 65 maybe a local area network (LAN) within an organization, a cellular network, the Internet, or a combination of different networks. A server computing device, namely a collaboration server 76, communicates with the network 65 over a suitable wireless connection, wired connection or a combined wireless/wired connection. The collaboration server 76 is configured to run a collaboration management application, for managing collaborative events by allowing collaboration participants to share audio, video and data information during a collaborative event. One or more participant computing devices 50 may also communicate with the network 65 over a wireless connection, a wired connection or a combined wireless/wired connection. Similarly, the participant computing devices 50 may be for example, desktop computers, tablet computers, laptop computers, smartphones, personal digital assistants, etc.

Each participant computing device 50 is configured to run a collaboration application. During running of the collaboration application, a graphical user interface is presented on a display of the participant computing device 50. After the collaboration application has been launched, the collaboration application presents a login screen (not shown). The login screen comprises a Session ID field (not shown), in which the Session ID of a desired collaborative event may be entered. The login screen also comprises a “Connect” button or icon (not shown), which may be selected to connect the participant computing device 50 to the collaborative event identified by the Session ID entered in Session ID field.

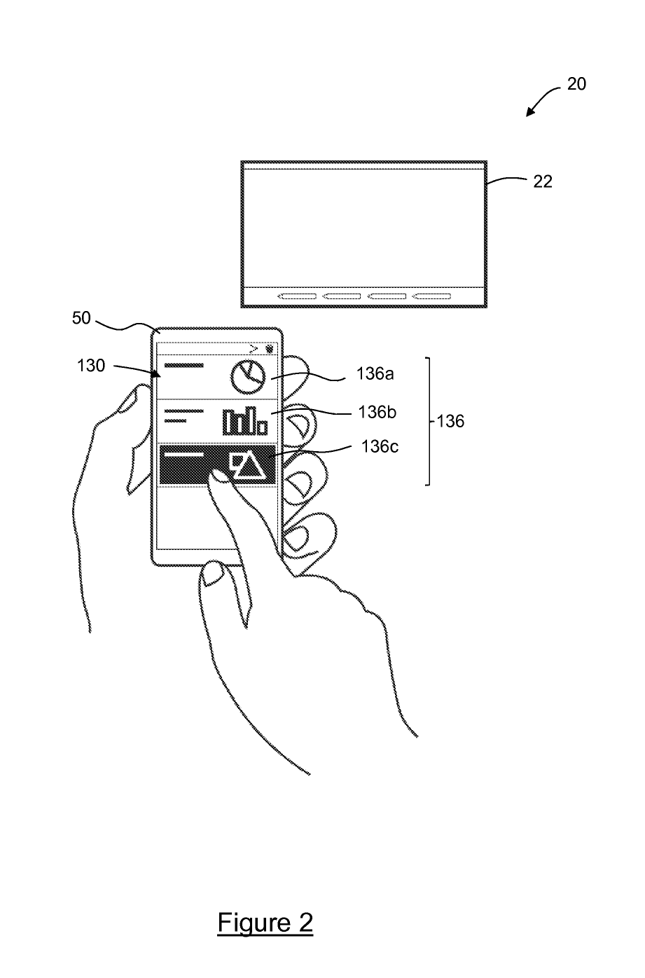

Upon connection to the collaborative event, the collaboration application presents a home screen (not shown) comprising a plurality of virtual buttons or icons selectable by the user of the participant computing device 50. The virtual buttons comprise a file share button (not shown). Selection of the file share button causes the collaboration application to present a file share screen 130 on the display screen of the participant computing device 50 as shown FIG. 2. File share screen 130 comprises a file list including one or more virtual buttons 136. Each virtual button 136 corresponds to a shareable file stored in memory of the participant computing device 50, and is selectable for sending the corresponding shareable file to one or more other computing devices. In the example shown, the file list comprises three (3) virtual buttons or icons 136, namely virtual buttons 136a, 136b and 136c.

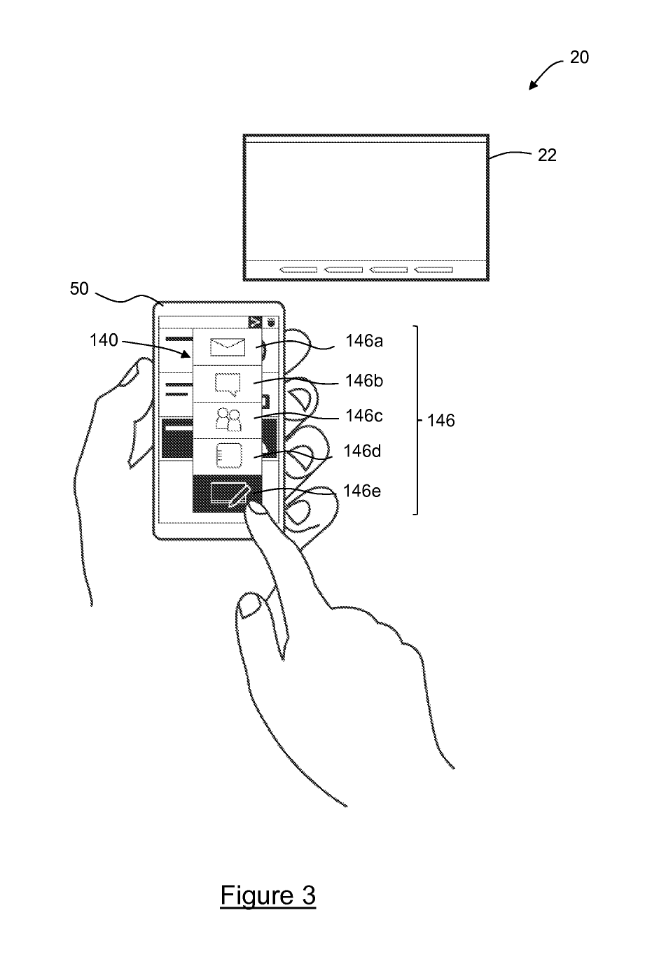

Selection of a virtual button 136 causes the collaboration application to present a share destination screen, which is shown FIG. 3 and is generally indicated by reference numeral 140. Share destination screen 140 comprises a destination list including one or more virtual buttons or icons 146. Each virtual button 146 corresponds to an available sharing destination for the shareable file corresponding to the selected virtual button 136. In the example shown, the file share screen comprises five (5) virtual buttons 146, namely an email virtual button 146a, a text message virtual button 146b, a social media virtual button 146c, a cloud storage virtual button 146d, and an interactive board virtual button 146e.

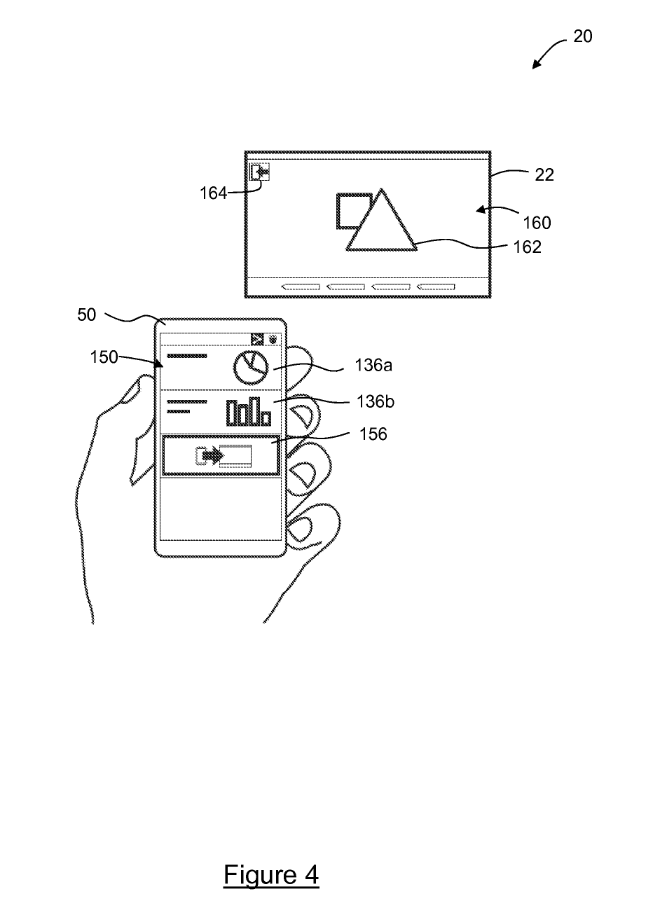

Selection of any virtual button 146 causes the collaboration application to send the shareable file corresponding to the selected virtual button 136 to the sharing destination corresponding to the selected virtual button 146. Once the shareable file has been sent, the collaboration application presents an updated shared file share screen, which is shown FIG. 4 and is generally indicated by reference numeral 150. Updated shared file share screen 150 comprises the file list of the one or more virtual buttons 136, with the selected virtual button 136 replaced with an updated virtual button 156 indicating that the shareable file corresponding to the selected virtual button 136 has been sent to the sharing destination corresponding to the selected virtual button 146.

Selection of the interactive board virtual button 146e causes the collaboration application to send the shareable file corresponding to the selected virtual button 136 to the collaboration server 76 as a shared file, which in turn forwards the shared file to the general purpose computing device 28. Upon receiving the shared file, the general purpose computing device 28 determines the file format of the shared file, such as for example JPEG, PDF, MS Word document, MS PowerPoint document, AutoCAD, and the like, and then launches an application program capable of opening, manipulating and saving files having the file format of the shared file. Once the application program has been launched, the general purpose computing device 28 presents an application window 160 on the interactive surface 24 of the interactive board 22. The application window 160 comprises an area in which the content 162 of the shared file is displayed, and a “return to sender” virtual button or icon 164, as shown in FIG. 4. In the example shown, the application window 160 is sized to occupy the entire interactive surface 24.

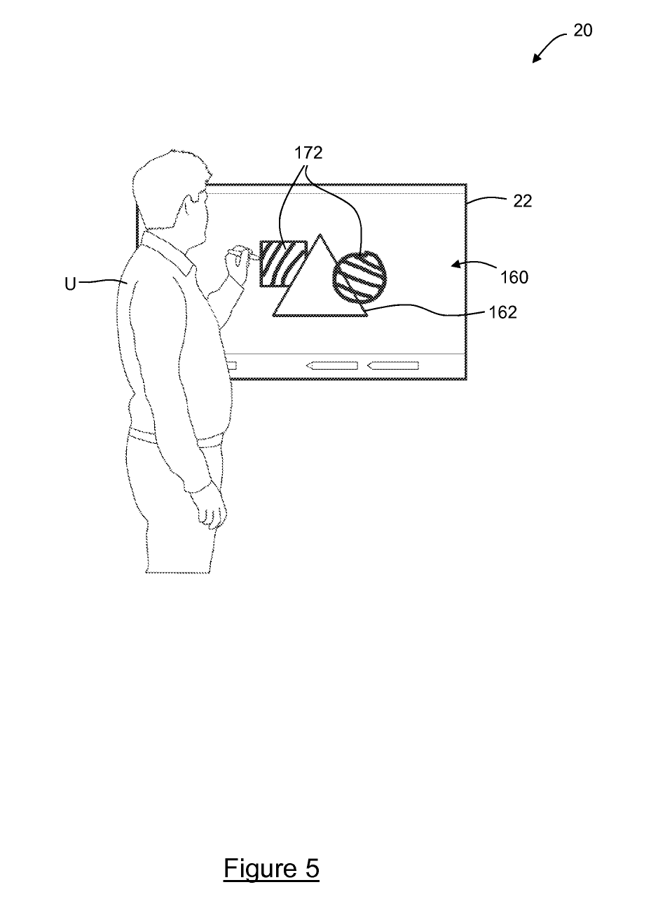

Once the application window 160 has been opened, the content 162 of the shared file may be manipulated by one or more users at the collaboration site by injecting input such as mouse events, digital ink, etc. into the application program running on the general purpose computing device 28. In the example shown in FIG. 5, a user U has injected input in the form of digital ink 172 into the content 162.

During the collaborative event, the general purpose computing device 28 continuously generates data that is representative of instantaneous images of the content currently displayed in the application window 160, which includes the content 162 of the shared file and injected input, if any. The general purpose computing device 28 sends the data as it is generated to the collaboration server 76, which then forwards the data to every participant computing device 50 joined to the collaborative event. Upon receiving the data, the collaboration application running on each participant computing device 50 processes the data, and continuously updates a corresponding image (not shown) of the application window 160 presented on the display of the participant computing device 50. As will be understood, in this manner, the corresponding image presented by the collaboration application reflects pointer activity on the interactive board 22 generally in real time. At any time during the collaborative event, users of the participant computing devices 50 may capture one or more images of the corresponding image, commonly referred to as “screenshots”. Such images are saved by the collaboration application in memory of the participant computing device 50, and have a generic image file format, irrespective of the file format of the shared file.

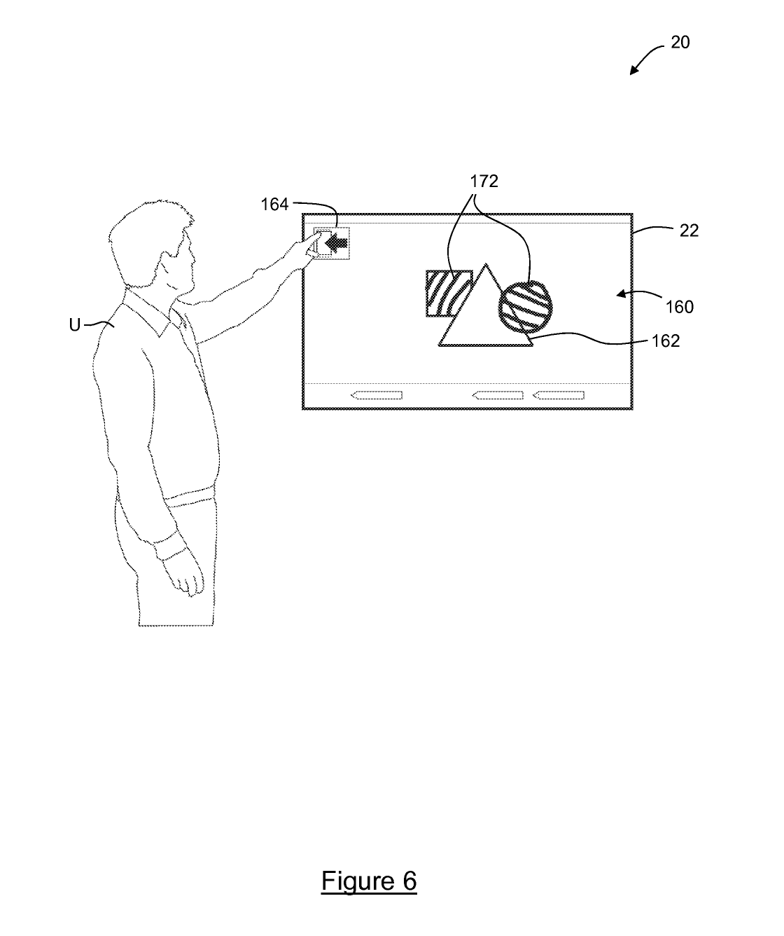

The “return to sender” virtual button 164 may be selected by a user at the collaboration site at any time during the collaborative event, or at the end of the collaborative event, as shown in FIG. 6. Upon selection of the “return to sender” virtual button 164, the general purpose computing device 28 saves the shared file, together with any input injected during the collaborative event (e.g. digital ink 172), as an updated shared file having the same file format as the shared file. The general purpose computing device 28 then sends the updated shared file to the collaboration server 76, which then forwards the updated shared file to only the participant computing device 50 that originally sent the shared file, and not to other participant computing devices 50 joined to the collaborative event.

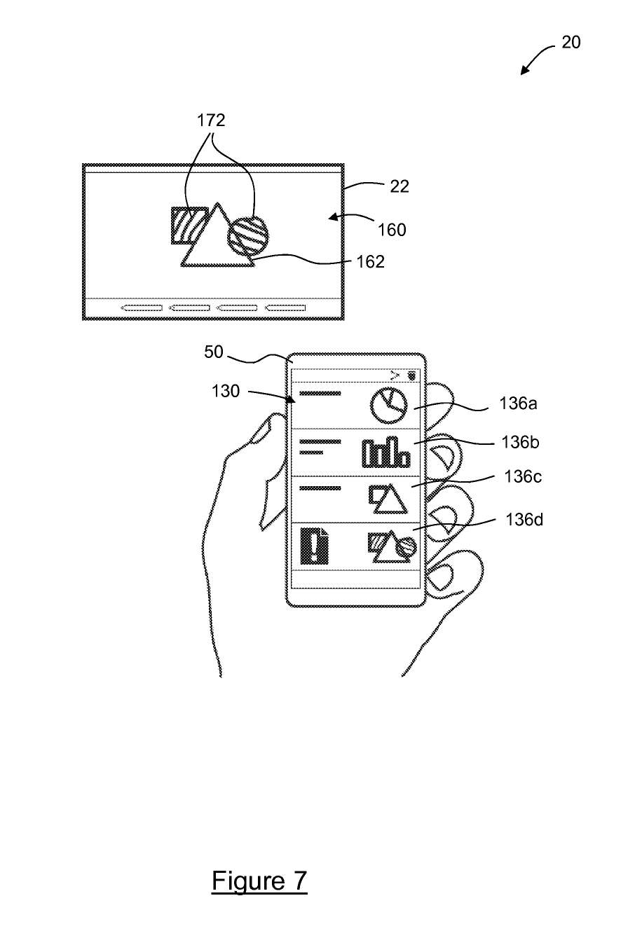

Upon receiving the updated shared file, the participant computing device 50 stores the updated shared file in memory. When the file share virtual button is selected again causing the collaboration application to present the file share screen 130, the file list is updated to comprise a virtual button 136d corresponding to the updated shared file, as shown in FIG. 7.

As will be appreciated, sending the shared updated file to only the participant computing device 50 that originally sent the shared file, and not to other participant computing devices 50 joined to the collaborative event, advantageously allows the sender of the shared file to control distribution of his or her original data. As will be understood, this prevents dissemination of the shared file to other participants joined to the collaborative event, which may otherwise occur without the consent of the sender of the shared file, and which may otherwise be undesirable for one or more of privacy reasons, confidentiality reasons, security reasons, ownership reasons, copyright reasons, and the like.

The collaboration management application and the collaboration application may each comprise program modules including routines, object components, data structures, and the like, and may each be embodied as computer readable program code stored on a non-transitory computer readable medium. The computer readable medium may be any data storage device that can store data. Examples of computer readable media include for example read-only memory, random-access memory, CD-ROMs, magnetic tape, USB keys, flash drives and optical data storage devices. The computer readable program code may also be distributed over a network including coupled computer systems so that the computer readable program code is stored and executed in a distributed fashion.

Other configurations are possible. For example, although in the embodiment described above, the file share screen comprises five (5) virtual buttons, namely an email virtual button, a text message virtual button, a social media virtual button, a cloud storage virtual button, and an interactive board virtual button, in other embodiments, the file share screen may alternatively comprise fewer or more virtual buttons. In a related embodiment, the file share screen may alternatively comprise one or more of a Blackberry messenger virtual button, a local wireless storage virtual button, a local wired storage virtual button, a remote wireless storage virtual button, a remote wired storage virtual button, and the like. Additionally, in participant computing devices 50 equipped with keyboards, virtual buttons may also be mapped to specific physical keys. Furthermore, in participant computing devices 50 without touch screens, icons corresponding to the virtual buttons may be mapped to specific physical keys.

Although in the embodiment described above, the general purpose computing device continuously generates data that is representative of instantaneous images of the content currently displayed in the application window, which includes the content of the shared file and injected input, if any, in other embodiments, the general purpose computing device may alternatively generate data that is representative of differences between instantaneous images of the content currently displayed in the application window and content previously displayed in the application window.

In other embodiments, upon selection of the “return to sender” virtual button, the general purpose computing device may additionally close the application window on the interactive surface of the interactive board once the updated shared file has been sent. In a related embodiment, selection of the “return to sender” virtual button may additionally end the collaborative event once the updated shared file has been sent.

In still other embodiments, once the collaborative event has ended, and once the general purpose computing device has sent the updated shared file to the collaboration server, the general purpose computing device may delete the shared file and the updated shared file.

Although in the embodiment described above, upon selection of the “return to sender” virtual button, the general purpose computing device saves the shared file, together with any input injected during the collaborative event (e.g. digital ink), as an updated shared file having the same file format as the shared file, in other embodiments, upon selection of the “return to sender” virtual button, the general purpose computing device may alternatively save only the input injected during the collaborative event (e.g. digital ink) as the updated shared file. The general purpose computing device then sends the updated shared file to the collaboration server, which then forwards the updated shared file to the participant computing device that originally sent the shared file. Upon receiving the updated shared file, the application program running on the participant computing device combines the updated shared file with either a previously-stored updated shared file, if one exists, or with the shareable file, and then saves the combined file as the updated shared file.

In a related embodiment, upon selection of the “return to sender” virtual button, the general purpose computing device may alternatively compare the input injected into the application program with the injected input of the previously-saved updated shared file, if one exists, to determine any differences in the injected input, and then save the determined differences in the injected input as the updated shared file.

Although in the embodiment described above, the interactive board is described as employing machine vision to register pointer input, those skilled in the art will appreciate that other interactive boards employing other machine vision configurations, analog resistive, electromagnetic, capacitive, acoustic or other technologies to register input may be employed. Also, the interactive board need not be mounted, supported or suspended in a generally upright orientation. The interactive board may take other non-upright orientations.

For example, interactive boards may be employed of forms such as for example: LCD screens with camera based touch detection (for example SMART Board™ Interactive Display, model 8070i); projector based interactive whiteboards employing analog resistive detection (for example SMART Board™ interactive whiteboard Model 640); projector based interactive whiteboards employing surface acoustic wave (SAW) touch detection; projector based interactive whiteboards employing capacitive touch detection; projector based interactive whiteboards employing camera based detection (for example SMART Board™, model SBX885ix); touch tables (for example SMART Table™, such as that described in U.S. Patent Application Publication No. 2011/0069019 assigned to SMART Technologies ULC, the relevant portions of the disclosure of which are incorporated herein by reference); slate computers (for example SMART Slate™ Wireless Slate Model WS200); and podium-like products (for example SMART Podium™ Interactive Pen Display) adapted to detect passive touch (for example fingers, pointer, etc, in addition to or instead of active pens).

Other types of products that utilize touch interfaces such as for example tablets, smartphones with capacitive touch surfaces, flat panels having touch screens, track pads, and the like may also be employed.

Although various embodiments of a collaboration system are shown and described, those of skill in the art will appreciate that the numbers of participant computing devices, collaboration servers and interactive boards illustrated and described is for illustrative purposes only and that the numbers of participant computing devices, collaboration servers and interactive boards can change.

For example, in other embodiments, the collaboration system may alternatively comprise multiple interactive boards connected to one or more general purpose computing devices, with each general purpose computing device being communicatively coupled to the collaboration server. As will be appreciated, each interactive board may be connected to its own respective general purpose computing device, and/or multiple interactive boards may be connected to a shared general purpose computing device. In one embodiment, selection of the interactive board virtual button on the share destination screen causes the collaboration application to send the shareable file to the collaboration server as a shared file, which in turn forwards the shared file to the one or more general purpose computing devices for display on each interactive board. Upon receiving the shared file, each general purpose computing device determines the file format of the shared file, and then launches an application program capable of opening, manipulating and saving files having the file format of the shared file. Once the application program has been launched, each general purpose computing device presents a shared application window on the interactive surface of each interactive board. Each shared application window comprises an area in which the content of the shared file is displayed, and a “return to sender” virtual button.

During the collaborative event, the one or more general purpose computing devices present the shared application window on each interactive board, which is updated in real time to reflect pointer activity on each of the interactive boards. Once the shared application windows have been opened, the content of the shared file may be manipulated by one or more users by injecting input such as mouse events, digital ink, etc. into the application program using any interactive board.

Each “return to sender” virtual button may be selected by a user at any time during the collaborative event, or at the end of the collaborative event. Upon selection of a “return to sender” virtual button, the general purpose computing device saves the shared file, together with any input injected during the collaborative event as an updated shared file having the same file format as the shared file.

Although embodiments have been described above with reference to the accompanying drawings, those of skill in the art will appreciate that variations and modifications may be made without departing from the scope thereof as defined by the appended claims.

What is claimed is:

1. A method of conducting a collaborative event, comprising:
receiving, by at least one computing device, a shared file from a participant computing device joined to the collaborative event;
displaying the shared file on at least one interactive board in communication with the at least one computing device during the collaborative event; and
sending an updated shared file from the at least one computing device to the participant computing device, the updated shared file comprising at least user input injected into the received shared file using the at least one interactive board.

2. The method of claim 1, wherein one or more additional participant computing devices are joined to the collaborative event, and wherein said sending comprises sending the updated shared file from the at least one computing device to only the participant computing device from which the shared file was received.

3. The method of claim 1, further comprising:
displaying an image of both the shared file and the user input on each participant computing device during the collaborative event.

4. The method of claim 1, further comprising:
displaying a virtual button on each interactive board during the collaborative event, wherein selection of the virtual button initiates said sending.

5. The method of claim 4, wherein selection of the virtual button causes the collaborative event to end.

6. The method of claim 1, further comprising:
after said sending, deleting from the at least one computing device one or both of the received shared file and the updated shared file.

7. The method of claim 1, wherein the updated shared file and the received shared file have the same file format.

8. A non-transitory computer-readable medium having embodied thereon a computer program for conducting a collaborative event, said program comprising instructions which, when executed by processing structure of at least one computing device, carry out:
receiving, by the at least one computing device, a shared file from a participant computing device joined to the collaborative event;
displaying the shared file on at least one interactive board in communication with the at least one computing device during the collaborative event; and
sending an updated shared file from the at least one computing device to the participant computing device, the updated shared file comprising at least user input injected into the received shared file using the at least one interactive board.

9. The non-transitory computer-readable medium of claim 8, wherein one or more additional participant computing devices are joined to the collaborative event, and wherein said sending comprises sending the updated shared file from the at least one computing device to only the participant computing device from which the shared file was received.

10. The non-transitory computer-readable medium of claim 8, further comprising instructions which, when executed by the processing structure of the at least one computing device, carry out:
displaying a virtual button on each interactive board during the collaborative event, wherein selection of the virtual button initiates said sending.

11. The non-transitory computer-readable medium of claim 8, wherein selection of the virtual button causes the collaborative event to end.

12. The non-transitory computer-readable medium of claim 11, further comprising instructions which, when executed by the processing structure of the at least one computing device, carry out:
after said sending, deleting from the at least one computing device one or both of the received shared file and the updated shared file.

13. The non-transitory computer-readable medium of claim 8, wherein the updated shared file and the received shared file have the same file format.

14. A collaboration system comprising:
at least one computing device in communication with a collaboration server computing device running a collaboration management application for hosting a collaborative event;
a participant computing device in communication with the at least one computing device, the at least one computing device being configured to receive a shared file from the participant computing device during the collaborative event; and
at least one interactive board in communication with the at least one computing device, each interactive board being configured, during the collaborative event, to display the shared file,
wherein the at least one computing device is further configured to send an updated shared file to the participant computing device, the updated shared file comprising at least user input injected into the received shared file using the at least one interactive board.

15. The system of claim 14, further comprising one or more additional participant computing devices joined to the collaborative event, wherein the at least one computing device is further configured to send the updated shared file to only the participant computing device from which the shared file was received.

16. The system of claim 14, wherein the at least one computing device is further configured to send image data representative of at least one of the displayed shared file and the user input to each participant computing device for display thereon during the collaborative event.

17. The system of claim 14, wherein the at least one computing device is further configured to display a virtual button on each interactive board during the collaborative event, and wherein selection of the virtual button initiates said sending.

18. The system of claim 17, wherein selection of the virtual button causes the collaborative event to end.

19. The system of claim 14, wherein the at least one computing device is further configured to, after said sending, delete one or both of the received shared file and the updated shared file.

20. The system of claim 14, wherein the updated shared file and the received shared file have the same file format.

21. An interactive board configured to:
during a collaborative event, display content of a shared file received from a participant computing device in communication therewith and joined to the collaborative event;
receive user input injected during the collaborative event; and
communicate the user input to a computing device in communication with the interactive board, the computing device being configured to send an updated shared file to the participant computing device, the updated shared file comprising at least the injected user input.

22. The interactive board of claim 21, wherein the interactive board is further configured to display a virtual button during the collaborative event, and wherein selection of the virtual button causes the computing device to send the updated shared file.

23. The interactive board of claim 22, wherein selection of the virtual button causes the collaborative event to end.

24. The interactive board of claim 21, wherein the updated shared file and the shared file have the same file format.

25. A participant computing device configured to:
during a collaborative event, send a shared file to at least one computing device for display on at least one interactive board; and
receive an updated shared file from the at least one computing device, the updated shared file comprising at least user input injected into the received shared file using the at least one interactive board.

26. The participant computing device of claim 25, wherein one or more additional participant computing devices are joined to the collaborative event, and wherein only the participant computing device from which the shared file was sent is configured to receive the updated shared file.

27. The participant computing device of claim 25, further configured to:
display an image of both the shared file and the user input during the collaborative event.
